(19) United States
(12) Patent Application Publication
(10) Pub. No.: US 2002/0128783 A1
(43) Pub. Date: Sep. 12, 2002

(54) Tube blockage sensing systems

(76) Inventors: Mike Marcu, Hamilton (CA); Sheldon Schilstra, St. Williams (CA)

Correspondence Address: Mike Marcu, 97 Thorndale Crescent, Hamilton, ON, L8S 3K3, CA

(21) Appl. No.: 09/877,887

(22) Filed: Jun. 11, 2001

(30) Foreign Application Priority Data
Jun. 7, 2000 (CA) 2,312,691

(51) Int. Cl. G01F 1/00; G01F 7/00; G06F 19/00

(52) U.S. Cl. 702/45

(57) ABSTRACT

Systems for detecting blockages in tubes are proposed based either by photoelectric sensing with illumination at one end or by an airflow and sensing with a flap valve and proximity or angle sensor at the other end.

### BACKGROUND OF THE INVENTION

1. Field of the invention

This intended invention relates to means of detecting blockages in short tubes. Also this intended invention relates to tubes with a maximum tube length equal with 300 times the cross dimension of the tube.

2. Prior Art

The known systems for detecting blockages in the above class of tubes are based on load cells, sensing the weight difference between the tube with blockage and the tube without blockage. Also there are different other variants based on neutronic rays, ultrasonics, laser detection or even sound/noise analysis.

The known detection systems involve software, calibration and time to do the measurement resulting ion time consuming operations. Also the practice proved that they are not safe in an environment requiring zero defects, zero rejects and zero maintenance required by the highly robotized environment in the intense production industrial corridors .

The object of this invention is to eliminate the above disadvantages by simplifying the detection process and increasing the safety of it. Also another objective of the invention is that by its implicit simplicity to make possible for the maintenance crews to be able to use it with minimal training and to be able to implement it easy in different other applications without the help of specialized personnel or specialized outside contractors. In a sense this will be a democratization of technology a delegation to the working people increasing the validity of the triple zero system (zero defects, zero rejects ,zero maintenance) in a totally automated environment.

### ESSENCE OF THE INVENTION

The foregoing and other objectives are achieved by this invention by the fact that is involving:

an open tube with two open ends one being called tube inlet the other being called the tube exit;

the tube having a diameter or a cross section dimension;

the tube having a length of maximum 300 diameters;

an object or structure called source;

the source being placed at the tube inlet or near it;

the source being able to produce a physical phenomenon like a electromagnetic field or an air movement called the detecting phenomenon;

the said phenomenon having the property of being able to be directed inside of the tube and having the property to be able to be propagated inside of the tube;

the source having directing means to direct the said phenomenon inside of the tube via the tube inlet;

sensing means able to sense the behaviour of the said phenomenon or variations of it;

the sensing means being placed either at the inlet of the tube or at the exit of the tube;

a tube blockage in form of an object able to enter or to be placed inside of the tube;

The way of operation of the proposed invention being as follows: the source is producing the said phenomenon which is propagated inside of the tube by the directing means ;when there is no tube blockage inside of the tube the sensing means detect a certain behaviour of the said phenomenon which is associated with the tube without blockage ;when there is a blockage on the tube then the said sensing means detect another behaviour of the said phenomenon or variations of it which are associated with the tube with blockage on it;

### EXAMPLES OF APPLICATION OF THE INVENTION BRIEF DESCRIPTION OF THE DRAWINGS

These and other objects, features and advantages of the invention will be better understood by reading the following detailed description in conjunction with the attached drawings, in which:

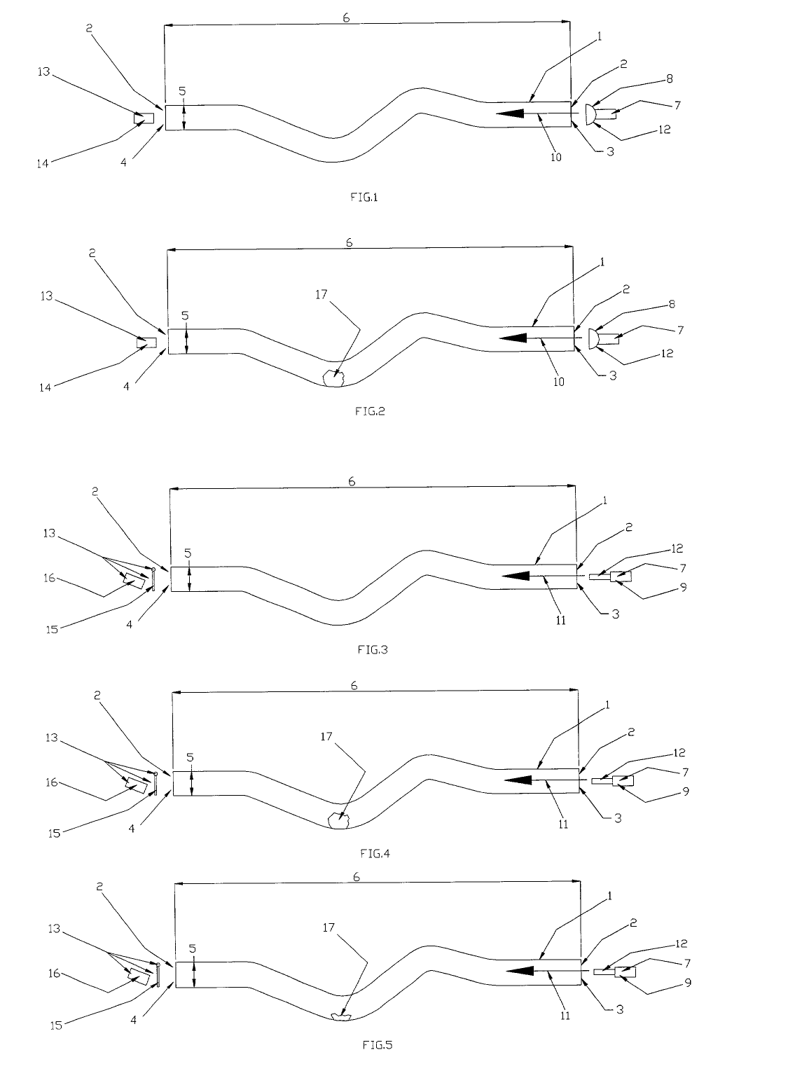

FIG. 1—The tube open-no blockage on it, detecting phenomenon being light and photoelectric detection;

FIG. 2—The tube with blockage ,detecting phenomenon being light and photoelectric detection;

FIG. 313 The tube open-no blockage, detecting phenomenon being an airflow inside of the tube and an air vane, which in this case is moved to maximum position

FIG. 4—The tube with blockage detecting phenomenon being airflow inside the tube and air vane—the air vane being moved to an intermediate position;

FIG. 5—The tube with blockage, detecting phenomenon being air flow inside the tube and air vane—the blockage being minimal—the airvane is fluttering, the fluttering is the discriminating signal for sensing the blockage.

### DETAILED DESCRIPTION OF THE EXAMPLES OF THE APPLICATION OF THE INVENTION

Below is given a illustration of the invention in relation with the FIGS. 1, 2, 3, 4, 5 describing examples of application of the invention involving/comprising the following:

an open tube 1 with two open ends 2 one being called tube inlet 3 and the other being called tube exit 4;

the tube having a diameter or a cross section dimension 5

the tube having a length 6 of maximum 300 diameters;

an object or structure 7 called source which can be either a light source 8 or an airflow source 9;

the source being placed at the tube inlet or near it;

the source being able to produce either a light pattern 10 or an airflow 11 inside of the tube;

the source having directing means 12 to direct the said light or airflow inside of the tube via the tube inlet;

sensing means 13 able to sense the behaviour of the said light or the said airflow inside the tube or variations of it;

the sensing means being placed either at the inlet of the tube or at the exit of the tube;

the sensing means for the case when we have the source producing light being a photoelectric detector 14;

a tube blockage 17 in form of an object able to enter or to be placed inside of the tube;

the said airflow inside the tube being maximum when there is no blockage in the tube;

the said light inside of the tube being of maximum intensity when there is no blockage in the tube;

the sensing means for the case when we have the source producing an airflow, being in form of an air vane or flap 15 and a proximity sensor or position sensor 16;

whereby the air vane or flap 15 being able to rotate under the influence of the air flow inside the tube, and being able to touch the proximity sensor 16 or to give an angle signal if we have at 16 a position sensor—when the airflow inside of the tube is maximum; the proximity sensor or position sensor being connected to an intelligent signal processor like a PLC, a dedicated microprocessor or similar;

a phenomenon we call aerodynamic flutter sensing defined as follows: when the blockage is small, then the airflow inside will generate a set of vortexes and the result at the exit of the tube, being that the air vane or flap will flutter oscillating between touching and not touching the proximity sensor or giving a random angle signal if we have an angle sensor there; in this way the random discontinued signal given by the proximity sensor or the angle sensor will be interpreted by the intelligent signal processor as a presence of a blockage in the tube;

a phenomenon we call photoelectric flutter sensing defined as follows: when the blockage is small, then the light pattern inside of the tube could be flickering around maximum and in this case the photoelectric detector could give a random sensing signal of presence and non presence of the blockage in the tube, signal which can be interpreted by the said intelligent signal processor as blockage present;

The way of operation of the illustrated examples is as follows: when the source is sending the light/air flow inside of the tube, a light or an airflow is established inside the tube; if there is no blockage in the tube, the sensing system is giving a maximum signal in this case the photoelectric detector will give a maximum signal and the air vane or flap will be blown or moved to the proximity switch by this having a non blockage signal; but when we have a blockage inside of the tube, then the light or the airflow inside of the tube will be modified and the sensing element will give an appropriate signal smaller than the one when we have nothing on the tube; the most interesting case is the flutter sensing when in both cases of photoelectric sensor and the air vane or flap we'll have a uncontrollable flutter of on off or random oscillations around a position—but this flutter will be easily interpreted by the intelligent signal processor as a blockage presence;

The embodiments of the invention in which an exclusive property or/and privilege under the laws is claimed are defined as follows:

1. System for detecting the blockages in tubes characterized by the fact that comprises:
an open tube with two open ends one being called tube inlet the other being called the tube exit;
the tube having a diameter or a cross section dimension;
the tube having a length of maximum 300 diameters;
an object or structure called source;
the source being placed at the tube inlet or near it;
the source being able to produce a physical phenomenon like a electromagnetic field or an air movement called the detecting phenomenon;
the said phenomenon having the property of being able to be directed inside of the tube and having the property to be able to be propagated inside of the tube;
the source having directing means to direct the said phenomenon inside of the tube via the tube inlet;
sensing means able to sense the behaviourr of the said phenomenon or variations of it;
the sensing means being placed either at the inlet of the tube or at the exit of the tube;
a tube blockage in form of an object able to enter or to be placed inside of the tube;

2. System for detecting blockages in tubes characterized by the fact that involves/comprises the following:
an open tube with two open ends one being called tube inlet and the other being called tube exit;
the tube having a diameterr or a cross section dimension;
the tube having a lengtht of maximum 300 diameters;
an object or structure called source which can be either a light source or an airflow source;
the source being placed at the tube inlet or near it;
the source being able to produce either a light patternn or an airflow inside of the tube;
the source havingg directing means to direct the said light or airflow inside of the tube via the tube inlet;
sensing means able to sense the behaviour of the said light or the said airflow inside the tube or variations of it;
the sensing means being placed either at the inlet of the tube or at the exit of the tube;
the sensing means for the case when we have the source producing light being a photoelectric detector;
a tube blockage in form of an object able to enter or to be placed inside of the tube;
the said airflow inside the tube being maximum when there is no blockage in the tube;
the said light inside of the tube being of maximum intensity when there is no blockage in the tube;
the sensing means for the case when we have the source producing an airflow, being in form of an air vane or flap and a proximity sensor or position sensor;
whereby the air vane or flap being able to rotate under the influence of the air flow inside the tube, and being able to touch the proximity sensor or to give an angle signal if we have at a position sensor—when the airflow inside of the tube is maximum;
the proximity sensor or position sensor being connected to an intelligent signal processor like a PLC, a dedicated microprocessor or similar;
a phenomenon we call aerodynamic flutter sensing defined as follows: when the blockage is small, then the airflow inside will generate a set of vortexes and the result at the exit of the tube, being that the air vane or flap will flutter oscillating between touching and not touching the proximity sensor or giving a random angle signal if we have an angle sensor there; in this way the random discontinued signal given by the proximity sensor or the angle sensor will be interpreted by the intelligent signal processor as a presence of a blockage in the tube;
a phenomenon we call photoelectric flutter sensing defined as follows: when the blockage is small, then the light pattern inside of the tube could be flickering around maximum and in this case the photoelectric detector could give a random sensing signal of presence and non presence of the blockage in the tube, signal which can be interpreted by the said intelligent signal processor as blockage present;
